(19) United States
(12) Patent Application Publication
(10) Pub. No.: US 2006/0129624 A1
(43) Pub. Date: Jun. 15, 2006

(54) Method and apparatus for performing a divide instruction

(76) Inventors: Mohammad A. Abdallah, Folsom, CA (US); Maheswara Lingareddy, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/008,848

(22) Filed: Dec. 9, 2004

(51) Int. Cl. G06F 7/52

(52) U.S. Cl. 708/650

(57) ABSTRACT

An apparatus and method to perform a division algorithm on an integer divisor and integer dividend. More particularly, embodiments of the invention relate to a technique to align integer operands such that a relatively fast division algorithm may be performed on the integer operands.

### FIELD

Embodiments of the invention relate to microprocessor architecture. More particularly, embodiments of the invention relate to a technique to perform a divide instruction that promotes improved microprocessor performance.

### BACKGROUND

Prior art techniques for performing division operations on integer operands within a microprocessor typically require a number of processing cycles that is dependent upon the register size of the integer divisor operand. For example, in at least one prior art integer divide technique, a 16-bit dividend divided by an 8-bit divisor requires 8 processor cycles, a 32-bit dividend divided by a 16-bit divisor requires 16 processor cycles, a 64-bit dividend divided by a 32-bit divisor requires 32 processor cycles, and a 128-bit dividend divided by a 64-bit divisor requires 64 cycles for a radix 2 integer division operation.

Furthermore, other prior art techniques for performing division operations require the divisor and dividend to be converted to floating point numbers, requiring a number of cycles to perform the division operation equal to the size of the dividend. In such a technique, a 64 bit dividend may require up to 64 cycles to divide. Furthermore, extra cycles may be needed to calculate the remainder of the result, in addition to more cycles needed to convert the floating point quotient and remainder back to the desired integer format including sign handling between 2's complement used in integer data and sign magnitude used in floating point data.

As integer operands continue to increase in size in modern microprocessor architectures, the cycles required to perform integer divide operations increases substantially.

### BRIEF DESCRIPTION OF THE DRAWINGS

Embodiments and the invention are illustrated by way of example and not limitation in the figures of the accompanying drawings, in which like references indicate similar elements and in which:

FIG. 1 illustrates logic that may be used to perform at least one embodiment of the invention.

FIG. 2 is a block diagram illustrating a technique for assigning the appropriate sign to the operands used in one embodiment of the invention.

FIG. 3 is flow diagram illustrating operations that may be used in one embodiment of the invention.

FIG. 4 illustrates a front-side bus computer system in which at least one embodiment of the invention may be used.

FIG. 5 illustrates a point-to-point computer system in which at least one embodiment of the invention may be used.

### DETAILED DESCRIPTION

Embodiments of the invention relate to microprocessor architecture. More particularly, embodiments of the invention relate to a technique for performing integer division operations within a microprocessor that requires fewer processing cycles for a given operand size than prior techniques.

Embodiments of the invention allow an integer dividend to be divided by an integer divisor without first converting the operands to a floating point format. Furthermore, embodiments of the invention reduce the number of cycles needed to perform the integer division, in relation to the prior art, to a number of cycles equal to the difference between the number of most significant zero bits more significant than the most significant non-zero bit (“leading zeros”) of the divisor and leading zeros of the dividend.

At least one embodiment of the invention improves integer division performance within a microprocessor by aligning the position of an integer divisor in relation to the floating point in order to make use of high-speed floating point division algorithms, which operate on normalized divisors. Specifically, in at least one embodiment, the integer operands are shifted in order to align the most-significant non-zero bits of the operands before performing an integer divide operation on the operands.

In one embodiment, the divisor is shifted left by a number of bit places such that the most significant non-zero bit resides in the most significant bit position of the register in which its contained or bus on which it is to propogate (collectively refered herein as a “datapath”). The dividend may also be shifted by an amount such that its most significant non-zero bit is also positioned in the most significant bit position of the register in which its contained. However, in other embodiments, the dividend may not be shifted by the full amount necessary to place its most signficant bit at the most significant bit position of the register in which its contained. Embodiments of the invention shift the dividend by an amount to allow the divide operation to take place using the minimum amount of processing cycles. Accordingly, embodiments of the invention typically require a number of cycles to perform the division operation equal to the difference between the most significant zero bits more significant than the most significant non-zero bit (“leading zeros”) of the divisor and dividend.

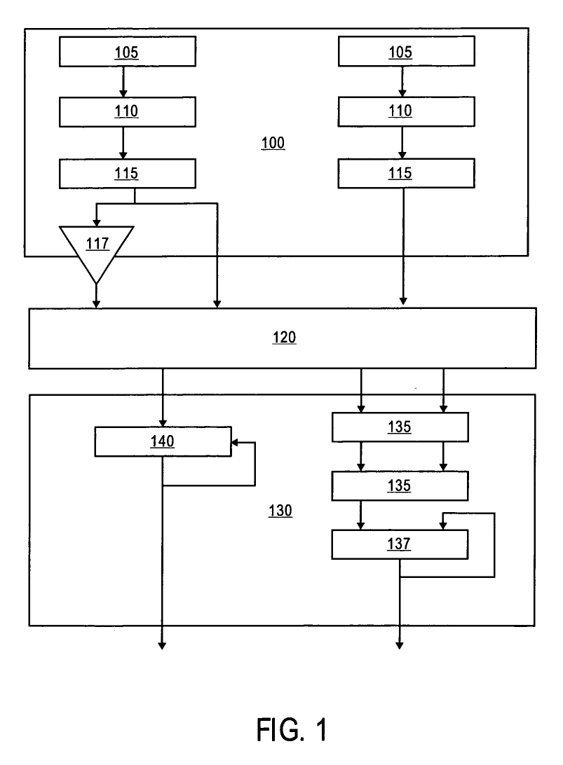

FIG. 1 illustrates logic associated with an integer divide architecture that may be used in one embodiment of the invention. In particular, FIG. 1 illustrates a pre-processing stage 100 in which operands of an integer divide operation are to be aligned before entering an internal loop 120 that performs the integer divide operation on the operands. The logic illustrated in FIG. 1 also contains a post-processing stage 130 in which, among other things, the remainder of the integer divide operation is aligned and the quotient converted to reflect the proper sign corresponding to the sign of the remainder.

The pre-processing stage includes a latch 105, an alignment shifter 110, and an 8-bit shifter 115. The shifters are used, in one embodiment, to normalize the dividend and divisor so that they are aligned with each other at the most significant non-zero bit. Although the embodiment illustrated in FIG. 1 uses two separate shifters, one being finer than the other, in other embodiments, more or fewer successive shifters may be used having coarser or finer shift granularity. By aligning the divisor and dividend to the most significant non-zero bit, fewer processing cycles are typically required to perform the integer division within the internal loop.

The divisor path of the pre-processing stage also contains an inverter 117 to provide the 1's complement of the divisor to the algorithm performed by the internal loop. In one embodiment of the invention, the internal loop performs a radix-2 floating point division algorithm on the integer operands, which requires that the divisor be a positive value, while the dividend may be a negative or a positive value. In other embodiments, other division algorithms, which do not require the divisor to be positive, may be used in the internal loop. However, in the embodiment illustrated in FIG. 1, the inverter 117 operates to provide the 1's complement of the divisor if the divisor is negative. Otherwise, the divisor is provided to the internal loop without being inverted.

In order to accommodate negative divisors in the embodiment illustrated in FIG. 1, the dividend's sign is changed such that the result of the divide operation will have the correct sign. For example, in one embodiment, if the divisor is negative and the dividend is positive, the divisor and dividend will be 2's complemented in order to provide a positive divisor to the internal loop, they will be 1's complemented in the pre-processing stage and a 1 will be added to it in order to provide the 2's complement of the dividend within the internal loop. In this way, the result of the divide operation will return a negative value. There may be other corrections in post processing for the remainder handling as a result of changing the signs of the divisor and the dividend in some embodiments. Similarly, if the divisor is negative and the dividend is negative, a positive division result is needed. Therefore, in order to provide a positive divisor to the internal loop, the divisor is 2's complemented and the dividend is 2's complemented by first generating the 1's complement in the pre-processing stage and then adding a 1 to the result in the internal loop.

The internal loop illustrated in FIG. 1 contains logic that may be used to implement any number of integer or floating point division techniques. However, in the embodiment illustrated in FIG. 1, the algorithm implemented by the internal loop is a floating point algorithm that operates on a positive divisor and operands that are at least substantially aligned to the most significant non-zero bit. The specific implementation of the internal loop divider may use various prior art techniques, however.

In the post-processing stage illustrated in FIG. 1, any negative remainders are converted into positive remainders and realigned. Likewise, a quotient corresponding to a negative remainder is converted into its proper value. For example, if the internal loop calculates 5 divided by 3, the result may return a quotient of 2 with a remainder of −1, depending upon the values of the divisor and the dividend. The remainder may be converted to a positive value and the quotient updated to a value corresponding to the positive remainder. In one embodiment of the invention, the negative remainder is added to a value that returns the appropriate positive remainder. In the above example, 3 would be added to the remainder of −1 to return the appropriate positive remainder of 2. The quotient would be updated by subtracting 1 from it to return a quotient of 1, thereby returning the appropriate result of the division of 5 by 3, which is a quotient of 1 with a remainder of 2.

Although any number of techniques may be used to convert the remainder and quotient, in the embodiment illustrated in FIG. 1, two 32 bit adders 135 are used to update a 64 bit remainder. A similar or different implementation may be used to update the corresponding quotient, such as using one 64 bit adder. Also included in FIG. 1 is a remainder realignment shifter 137 and quotient realignment shifter 140. The remainder and quotient are realigned by shifting them to the right by the amount the divisor was shifted to the left during the pre-processing stage.

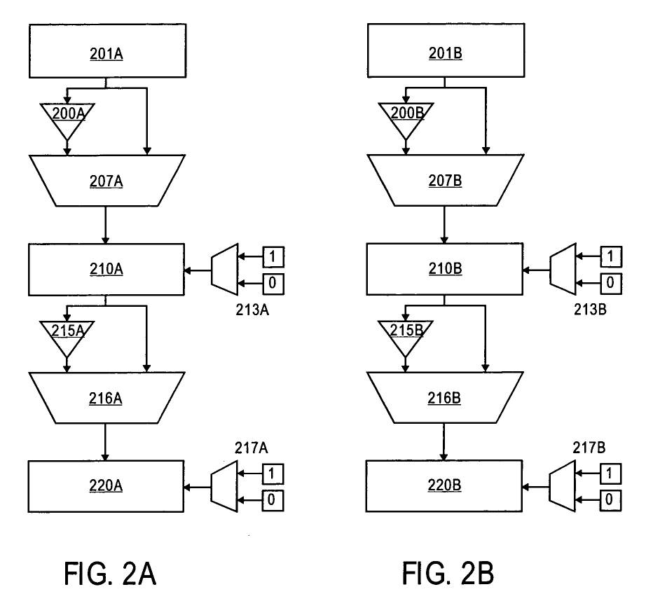

FIG. 2 illustrates logic that may be used to generate a dividend with the proper sign, according to one embodiment. In some embodiments, the sign of the dividend and divisor may be adjusted through other means. Furthermore, in other embodiments, no adjustment of the divisor's or dividend's sign may occur.

FIG. 2a illustrates the propagation of the dividend stored in register 201a and the corresponding added values for the case of a positive dividend and a negative divisor. In FIG. 2a, the dividend propagation and added values (illustrated by the thicker lines and arrows) illustrate that if there is a negative divisor, a positive dividend will not be inverted by inverter 205a, so that the original sign of the dividend is maintained into the alignment shifter 210a via mux 207a, where zeros 213a are shifted into the least most significant bit places of the divisor as the divisor is shifted right by a number of times equal to or less than the difference between the position of most significant bit of the divisor and dividend. The thick dividend propagation arrow also indicates that the positive dividend propagates through the inverter 215a to generate the 1's complement of the dividend and then through mux 216a. Finally, a one 217a is added to the result by adder 220a to generate the 2's complement of the dividend. The result may then be propagated to the inner loop illustrated in FIG. 1 to perform the division.

FIG. 2b illustrates the propagation path of the dividend through the conversion logic if the dividend is negative and the divisor is negative. The negative dividend is stored in register 201b. In FIG. 2b, the dividend propagation and added value arrows (indicated by the thicker lines and arrows) illustrates that if there is a negative divisor, a negative dividend will be inverted by inverter 205b, so that the original sign of the dividend is converted to its 1's complement and stored in the alignment shifter 210b via mux 207b, where ones 213b are shifted into the least most significant bit places of the divisor as the divisor is shifted right by a number of times equal to or less than the difference between the position of most significant bit of the divisor and dividend. The heavy dividend propagation arrow also indicates that the negative dividend bypasses the inverter 215b and is stored in mux 216b. Finally, a one 217b is added to the result by adder 220b to generate the 2's complement of the dividend. The result may then be propagated to the inner loop illustrated in FIG. 1 to perform the division.

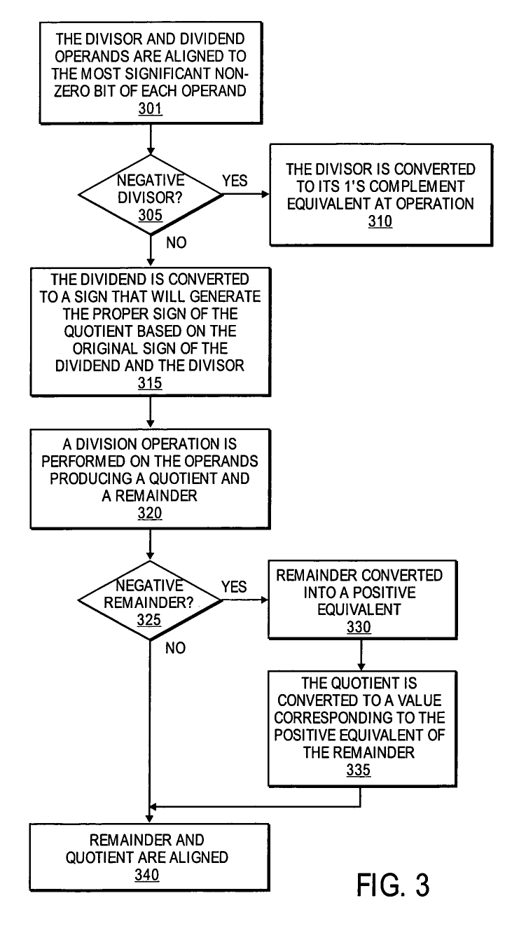

FIG. 3 is a flow diagram illustrating operations used in at least one embodiment of the invention. At operation 301, the divisor and dividend operands are aligned to the most significant non-zero bit of each operand. In one embodiment of the invention, this means shifting at least the divisor to the right by an amount equal to the difference between the number of most significant zero bits more significant than the most significant non-zero bit of the divisor and dividend, respectively. Furthermore, at operation 305, if the divisor is negative, the divisor is converted to its 1's complement equivalent at operation 310. At operation 315, the dividend is converted to a sign that will generate the proper sign of the quotient based on the original sign of the dividend and the divisor. In other embodiments, operations 305 through 315 may not be performed or may be performed in other ways, as required by a particular implementation. At operation 320, a division operation is performed on the operands producing a quotient and a remainder.

At operation 325, if the remainder is a negative number, it is converted into a positive equivalent by adding an appropriate value thereto at operation 330. Furthermore, if the remainder is negative, the quotient is converted to a value corresponding to the positive equivalent of the remainder at operation 335. The remainder and quotient are then aligned, at operation 340, by shifting each to the right a number of bit places equal to the difference between the most significant zeros appearing before the most significant non-zero in the original divisor and dividend, respectively.

Embodiments of the invention described so far have used radix-2 operands. It will be appreciated that embodiments that use higher order radices may benefit from the principals taught herein, as they would require fewer iterations of the internal loop divider, thereby improving performance. Furthermore, embodiments of the invention described herein may be used within various computing devices and platforms.

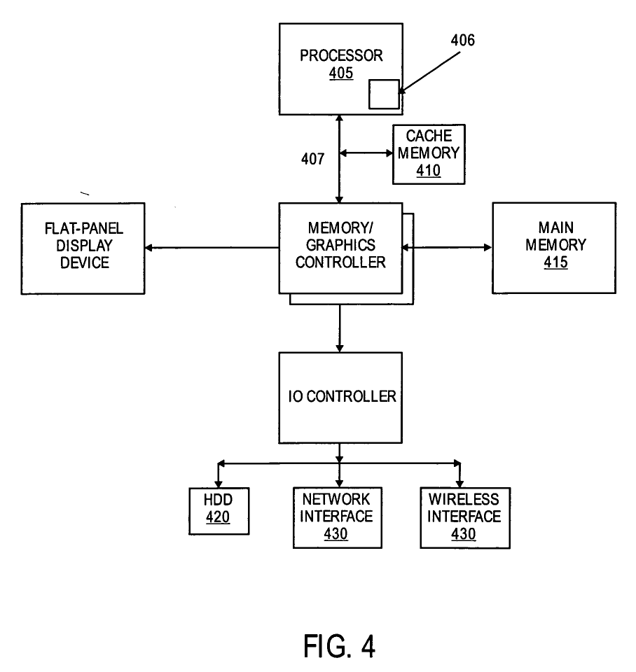

FIG. 4, for example, illustrates a front-side-bus (FSB) computer system in which one embodiment of the invention may be used. A processor 405 accesses data from a level one (L1) cache memory 410 and main memory 415. In other embodiments of the invention, the cache memory may be a level two (L2) cache or other memory within a computer system memory hierarchy. Furthermore, in some embodiments, the computer system of FIG. 4 may contain both a L1 cache and an L2 cache, which comprise an inclusive cache hierarchy in which coherency data is shared between the L1 and L2 caches.

Illustrated within the processor of FIG. 4 is one embodiment of the invention 406. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 420, or a memory source located remotely from the computer system via network interface 430 containing various storage devices and technologies. The cache memory may be located either within the processor or in close proximity to the processor, such as on the processor's local bus 407. Furthermore, the cache memory may contain relatively fast memory cells, such as a six-transistor (6T) cell, or other memory cell of approximately equal or faster access speed.

The computer system of FIG. 4 may be a point-to-point (PtP) network of bus agents, such as microprocessors, that communicate via bus signals dedicated to each agent on the PtP network. Within, or at least associated with, each bus agent is at least one embodiment of invention 406, such that store operations can be facilitated in an expeditious manner between the bus agents.

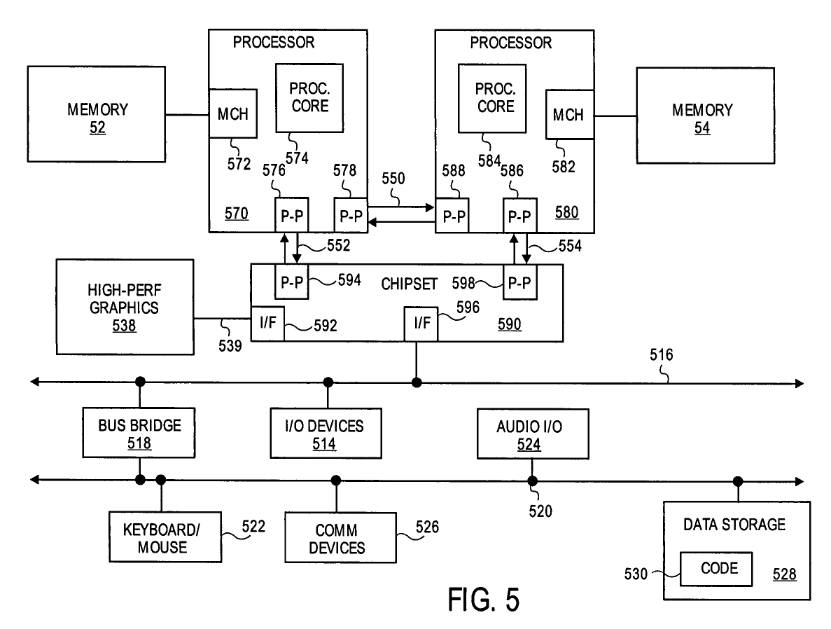

FIG. 5 illustrates a computer system that is arranged in a point-to-point (PtP) configuration. In particular, FIG. 5 shows a system where processors, memory, and input/output devices are interconnected by a number of point-to-point interfaces.

The system of FIG. 5 may also include several processors, of which only two, processors 570, 580 are shown for clarity. Processors 570, 580 may each include a local memory controller hub (MCH) 572, 582 to connect with memory 22, 24. Processors 570, 580 may exchange data via a point-to-point (PtP) interface 550 using PtP interface circuits 578, 588. Processors 570, 580 may each exchange data with a chipset 590 via individual PtP interfaces 552, 554 using point to point interface circuits 576, 594, 586, 598. Chipset 590 may also exchange data with a high-performance graphics circuit 538 via a high-performance graphics interface 539.

At least one embodiment of the invention may be located within the PtP bus agents of FIG. 5. Other embodiments of the invention, however, may exist in other circuits, logic units, or devices within the system of FIG. 5. Furthermore, other embodiments of the invention may be distributed throughout several circuits, logic units, or devices illustrated in FIG. 5.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
a first alignment unit to shift a first integer division operand by a first number of bit places, the first number being equal to an amount sufficient to align the most significant non-zero bit to the most significant bit position of a datapath.

2. The apparatus of claim 1 further comprising a second alignment unit to shift a second integer division operand by a second number of bit places, the second number being less than or equal to the first number.

3. The apparatus of claim 2 further comprising sign logic to convert a negative first operand into a positive first operand and to convert the second operand's sign based upon a product of the sign of the first operand and the sign of the second operand.

4. The apparatus of claim 1 further comprising a divider circuit to perform a floating point division operation of the first and second operands.

5. The apparatus of claim 4 further comprising quotient conversion and correction logic to adjust the value of the quotient based on the sign of a remainder of the division operation and to shift the quotient by the negative value of the first number.

6. The apparatus of claim 5 further comprising remainder conversion and correction logic to adjust the value of the remainder based on the sign of the remainder of the division operation and to shift the remainder by the negative value of the first number.

7. The apparatus of claim 1 wherein the first number is a divisor and the second number is a dividend.

8. The apparatus of claim 3 wherein the first and second alignment units are to shift the first and second operands left, respectively.

9. A method comprising:
aligning a most significant non-zero bit of a first integer division operand and a second integer division operand;
performing a floating point division algorithm on the first and second integer division operands;
converting a sign of a quotient and a remainder resulting from the division algorithm.

10. The method of claim 9 further comprising adjusting the sign of the first operand such that the first operand has a positive value and adjusting the sign of the second operand based on a product of the sign of the first operand and the sign of the second operand.

11. The method of claim 10 wherein the first operand is the divisor and the second operand is the dividend.

12. The method of claim 11 further comprising converting the sign of a remainder of the division algorithm from negative to positive.

13. The method of claim 12 further comprising converting the quotient of the division algorithm to a value corresponding to the converted sign of the remainder.

14. The method of claim 13 wherein the aligning comprises shifting the divisor by a first amount sufficient to align the most significant non-zero bit to the most significant bit position of a datapath.

15. The method of claim 14 wherein the quotient and the remainder are shifted by a second amount equal to the negative of the first amount.

16. The method of claim 15 wherein the division algorithm is a radix-2 division algorithm.

17. The method of claim 15 wherein the division algorithm is a radix-10 division algorithm.

18. A system comprising:
a memory to store instructions, which when executed, are to perform a floating point division operation on an integer divisor and an integer dividend;
a processor to execute the instructions and to align the most significant non-zero bits of the divisor and dividend prior to performing the division operation;
an audio device coupled to the processor.

19. The system of claim 18 wherein the processor is to align the most significant non-zero bits by performing a left shift operation on the divisor, the left shift operation to shift the divisor left by an amount sufficient to align the most significant non-zero bit to the most significant bit position of a datapath.

20. The system of claim 18 wherein the processor is to generate the 1's complement of the divisor if the divisor is negative before performing the division operation.

21. The system of claim 20 wherein the processor is to generate the 2's complement of the dividend if the divisor is positive and the dividend is negative prior to performing the division operation.

22. The system of claim 20 wherein the processor is to generate the 2's complement of the dividend if the divisor is negative and the dividend is positive prior to performing the division operation.

23. The system of claim 20 wherein the processor is to perform a right shift operation on a quotient and a remainder of the division operation, the right shift operation to shift the quotient and the remainder right.

24. The system of claim 23 wherein the processor is to invert the sign of the remainder if the remainder is negative.

25. The system of claim 24 wherein the processor is to add a value to the quotient if the remainder is negative such that the quotient corresponds to the positive value of the remainder.

26. A machine-readable medium having stored thereon a set of instructions, which when executed by a machine, cause the machine to perform a method comprising:
aligning two integer operands with each other before performing a floating point division operation on the operands;
performing the floating point division operation on the operands, the operation having a number of processing cycles equal to the difference between the most significant non-zero bits more significant than the most significant zero bit of the two integer operands;
converting a negative remainder resulting from the floating point operation into a positive remainder.

27. The machine-readable medium of claim 26 further comprising instructions to convert a first of the two integer operands from a negative value to a positive value before performing the division operation.

28. The machine-readable medium of claim 27 further comprising instructions to convert the sign of a second of the two integer operands based, at least in part, on the sign of the first operand before performing the division operation.

29. The machine-readable medium of claim 28 wherein the first operand is a divisor and the second operand is a dividend.

30. The machine-readable medium of claim 29 wherein the division operation results in fewer processing cycles than a division operation performed on unaligned operands of the same size as the aligned operands.
